(19) United States
(12) Patent Application Publication
(10) Pub. No.: US 2008/0031680 A1
(43) Pub. Date: Feb. 7, 2008

(54) MOBILE OFFICE ORGANIZER

(75) Inventors: Ravi Buddharaju, Houston, TX (US); Laurence Choi, Seoul (KR); Marta DePaul, Pittsburgh, PA (US); Jason DePerro, San Jose, CA (US); Andrew Lerner, New York, NY (US); Anu Melville, Northboro, MA (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/758,090

(22) Filed: Jun. 5, 2007

Related U.S. Application Data
(60) Provisional application No. 60/804,295, filed on Jun. 9, 2006.

(51) Int. Cl. B42F 3/04

(52) U.S. Cl. 402/35

(57) ABSTRACT

A mobile office organizer and portfolio provide an organizer with a front pocket for storage of the portfolio when not in use, and a portfolio which provides for internal storage of documents when not in use and external mounting of documents when required for modification or reference. The portfolio is based on a flexible cover which can be folded and closed, and which includes a ring and binder assembly for organization and retention of sheets. The rings of the ring and binder assembly extend from the interior to the exterior of the portfolio allowing papers to be mounted thereon either inside or outside of the covers.

### REFERENCE TO RELATED APPLICATION

The present application relates to and claims priority from U.S. Provisional Patent Application No. 60/804,295, filed 9 Jun. 2006.

### BACKGROUND OF THE INVENTION

1. Technical Field

The present invention relates to storage and organization of articles, particularly papers, for access by a driver or passenger of a motor vehicle.

2. Description of the Problem

A variety of organizer systems with complementary accessories exist in the art. The state of the art was well summarized in U.S. Pat. No. 7,210,936 to Moeller, et al. where it was observed that a need remained for systems that include the components, options and flexibility needed to organize, plan, store, transport and display items suited for specific jobs or projects. Such an organizer should take into account the environment in which the person using the organizer will find him or herself and what items the individual will need to access and use with regularity. An organizer used by a truck driver should take into account the overriding need for organizing, accessing and working with papers, permits, licenses, bills of lading, order forms, return slips, log books and more. A truck driver is confronted with a premium on living space and a need to carry his paperwork around, compounding the problems of keeping his paper work organized. Much of the paperwork must be processed and triple-checked every time a trucker drops off a shipment. The logbooks, purchase orders, and other shipping forms can add up to between 10 and 20 pages of paperwork per trip.

### SUMMARY OF THE INVENTION

It is an object of the invention to provide a combination binder, writing surface and file/small object organizer which is readily stored on or removed from a vehicle.

The invention provides a mobile office organizer portfolio including a fabric cover having interior and exterior major surfaces and a perimeter, a closure disposed along the perimeter for closing the fabric cover along a fold, a spine located on the exterior major surface running transversely across the exterior major surface and roughly dividing the exterior major surface into first and second sections, a writing surface located on a portion of the first section of the exterior major surface adjacent the spine, a binder assembly including a plurality of rings extending from the interior major surface and located parallel to the spine, the spine and the binder assembly defining the fold in the fabric cover with the binder assembly being positioned substantially opposite the spine when the fabric cover is folded on the fold, and a plurality of openings through the fabric cover located to align on the plurality of rings of the binder assembly upon closure of the fabric cover allowing portions of the rings to protrude from the fabric cover and thereby to extend from the exterior surface along one side of the writing surface. An organizer bag including a front accessible pocket for receiving the portfolio completes a mobile office.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is perspective view of a portfolio for the invention.

FIG. 2 is perspective view of the interior surface of an opened portfolio.

FIG. 3 is a perspective view of the exterior surface of the opened portfolio.

FIG. 4 is a circuit schematic for the illumination feature of the invention.

FIG. 5 is a plan view of a flat sheet insert used with the portfolio.

FIG. 6 is a plan view of the flat sheet insert being fixed to the exterior surface of the portfolio.

FIG. 7 is a perspective of an organizer bag.

FIG. 8 is a perspective view of a file holding frame for insertion into the organizer bag.

FIG. 9 is an additional view of the organizer bag.

### DETAILED DESCRIPTION OF THE INVENTION

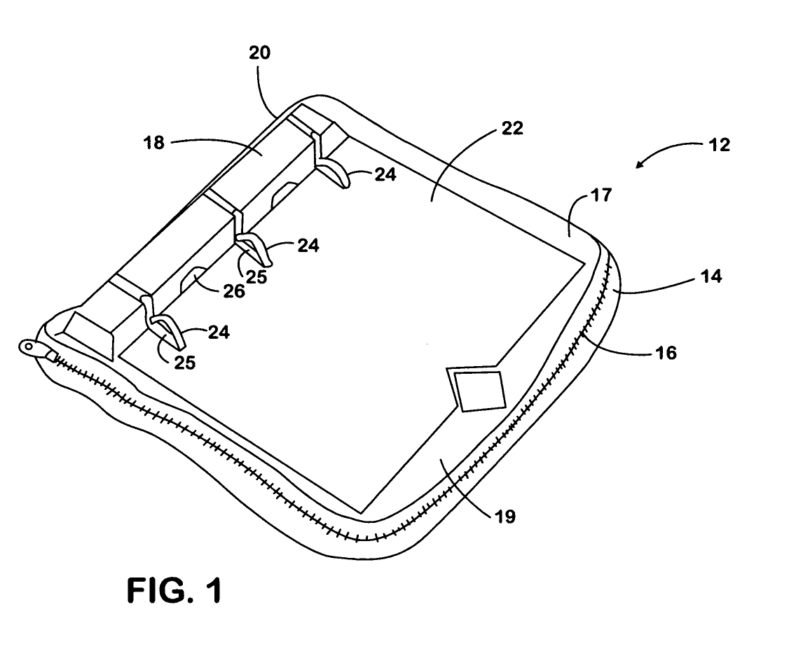

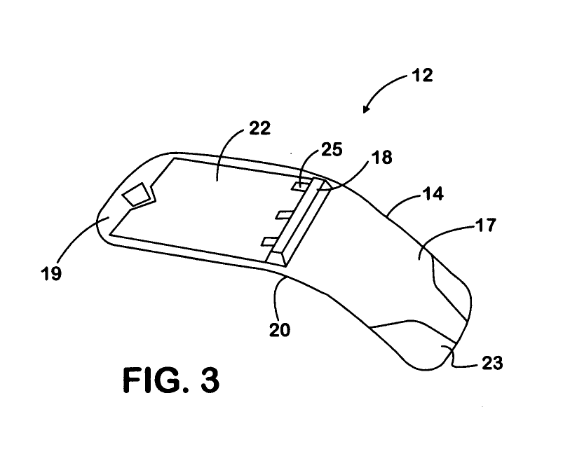

Referring now to the drawings and in particular to FIG. 1 a portfolio 12 for a mobile office organizing system is shown. Portfolio 12 includes a fabric cover 14 which is illustrated as being closed on itself along its perimeter by a perimeter closure provided by a bidirectional zipper 16. Fabric cover 14 has a major surface 17 which, upon closure of the portfolio 12, becomes an exterior major surface with a front portion 19 and a back portion (see FIG. 3).

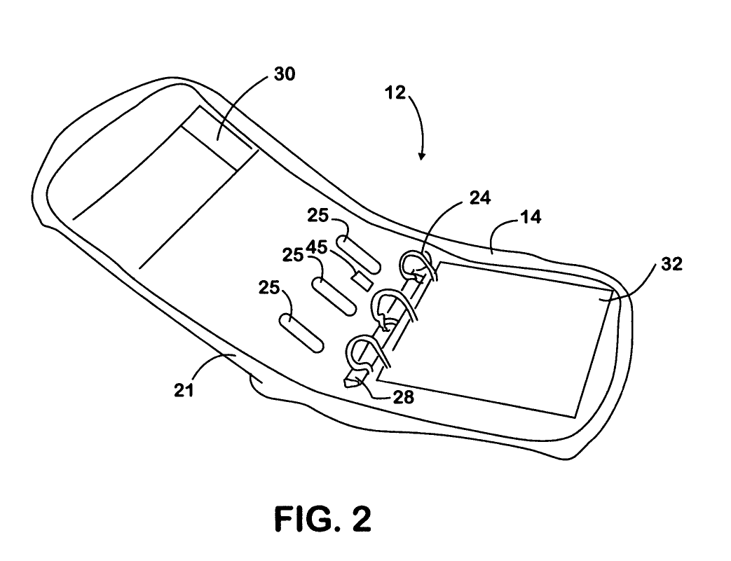

Portfolio 12 allows the external attachment of papers (or other inserts) to rings 24 of a ring and binder assembly (shown in FIG. 2) which places the papers over a relatively rigid writing surface 22 inlaid on the front portion 19 of the fabric cover 14. To allow ease in writing or reading illumination elements 26, typically based on light emitting diodes, are located in spine 18 which borders one edge of the writing surface 22. Rings 24 are partially exposed from the interior of portfolio 12 through holes 25 through the fabric cover 14. Rings 24 are mounted to a ring and binder assembly installed on the interior surface as described below and protrude through the fabric cover 14 to be accessible from outside of the portfolio 12.

Fabric cover 14 is, in overall configuration, a rectangular sheet. A spine 18 is located on and extends outwardly from the exterior surface 17 of the fabric cover 14, running transversely from side to side of the fabric cover parallel to the short symmetric axis of the cover. Spine 18 is located just to one side of the short symmetric axis, being located on the front portion 17 of the exterior surface 17. The location of the spine 18 helps to define a fold 20 to the fabric cover which corresponds in location to the short symmetric axis. By being raised, spine 18 partially protects rings 24 against accidental damage stemming from inadvertent collisions.

FIG. 2 illustrates portfolio 12 opened to expose the second, or interior, major surface 21 of portfolio 12. When portfolio 12 is opened, a ring and binder assembly 28 is exposed. Ring and binder assembly 28 is positioned on the interior major surface 21 of fabric cover 14, running parallel to the spine 18, but along the opposite side of the fold 20, both spine and assembly thus being parallel to the short symmetric axis of the fabric cover 14. Rings 24 align on each of holes 25 upon folding of the fabric cover 14 along the short axis fold 20. An insert 32, such as a piece of paper, separator, or sheet protector, is illustrated placed on rings 24. Rings 24 may be fixed, or may be of the type which opens. A business card and license slot 30 is also located on the interior surface 21 of fabric cover underneath the relatively stiff writing surface on the exterior surface of the fabric cover 12. A switch 45 for turning illumination elements 26 on and off is located on the interior surface 21 underneath the spine 18.

FIG. 3 illustrates portfolio 12 opened and inverted to show the exterior surface 17 of fabric cover 14 in its entirety. Spine 18 is located along fold 20 with the writing surface 22 extending over much of the front portion 19 of the portfolio 12. Holes 25 are located along spine 18 in and through one edge of writing surface 22. A back cover 23 incorporates the portion of exterior surface 17 on the opposed side of fold 20 from the writing surface 22.

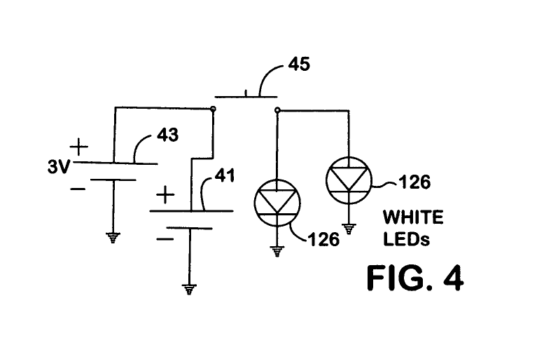

FIG. 4 is a circuit diagram for an energization circuit for the illumination elements 26, which are provided here by super bright white light emitting diodes 126. A pair of parallel connected batteries 41, 43 are connected to supply electricity by closure of a momentary switch 45 to parallel connected LED's 126.

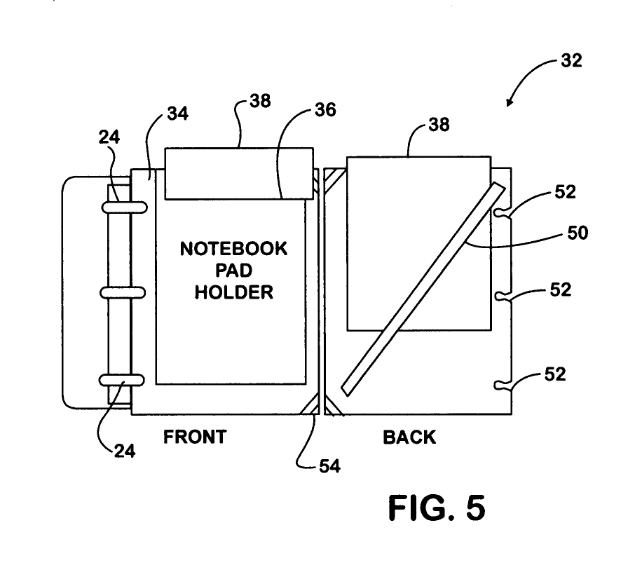

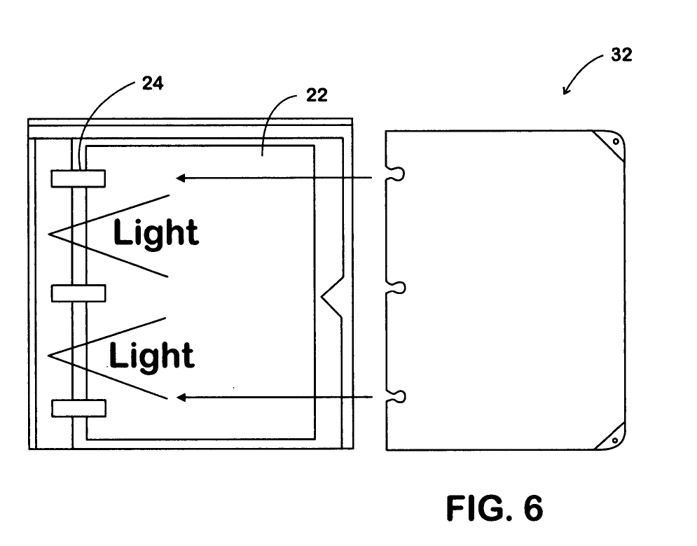

FIG. 5 illustrates a removable insert 32, front and back, used with the portfolio 12. Insert 32 comprises a sheet protector body 34 having a rectangular shape along one side of which are disposed a plurality of slots 52. Slots 52 are located and sized to fit onto rings 24. The insert 32 may be placed on the rings 24 allowing the portfolio 12 to be closed, or the insert may be placed on rings 24 where they protrude through cover 14 after closure of the portfolio 12, placing them outside the portfolio over the writing surface 22 (shown in FIG. 6). Inserts 32 may take a number of forms. As illustrated insert 32 is a sheet protector 34, modified to include a front slot 36 located in the front sheet of the sheet protector 34 and which admits the base of a note pad 38. On the back of the sheet protector body 34 a diagonal retaining strap 50 is disposed. Sheets of pad 38 may be folded over the top of the insert 32 and pushed between the strap 50 and body of the sheet protector 34 to be restrained from being blown about. The corners of the edge of the sheet protector 34 distal to the edge including the slots 52 carry magnets 54. Writing surface 22 may be backed with a magnetically susceptible material which gives rise to an attraction between it and the magnets 54, tending to retain inserts 32 against the writing surface.

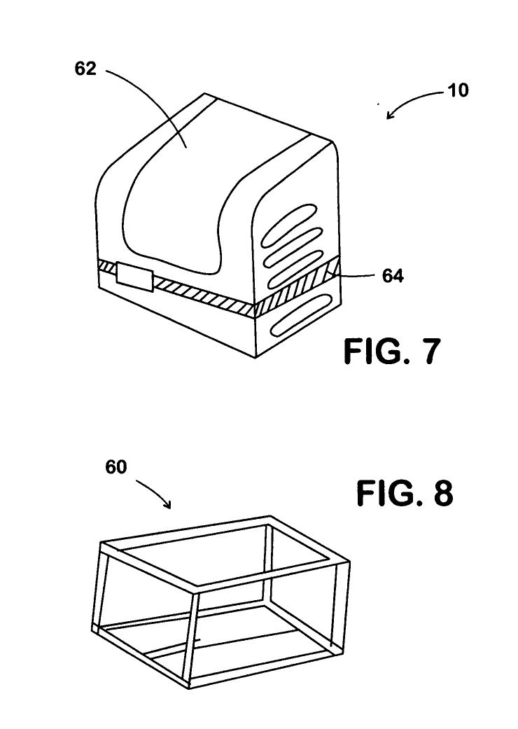

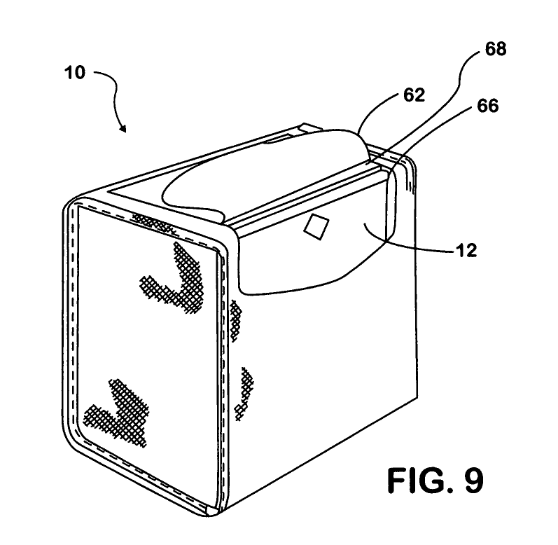

Portfolio 12 is advantageously used with bag 10 adapted to provide an accessible pocket for the portfolio and sized to allow introduction of file frame 60 as illustrated in FIGS. 7-9. Bag 10 is equipped with a shoulder strap 64 and a closure flap 62. Frame 60 fits into a compartment 68 occupying the back of bag 10, leaving a forward pocket 66 accessible at the front of the bag. Forward pocket 66 is sized to hold snugly the portfolio 12. Flap 62 opens from the front, and can be rolled toward the back of bag 10, to expose the pocket 66 without exposing files located in the file frame 60. This permits easy access to the portfolio 12, which is expected to be used for currently active matters.

While the invention is shown in only one of its forms, it is not thus limited but is susceptible to various changes and modifications without departing from the spirit and scope of the invention.

What is claimed is:

1. A portfolio comprising:
a fabric cover having interior and exterior major surfaces and a perimeter;
a closure disposed along the perimeter for closing the fabric cover along a fold;
a spine located on the exterior major surface running transversely across the exterior major surface and roughly dividing the exterior major surface into first and second sections;
a writing surface located on a portion of the first section of the exterior major surface adjacent the spine;
a binder assembly including a plurality of rings extending from the interior major surface and located parallel to the spine, the spine and the binder assembly defining a fold in the fabric cover; and
a plurality of openings through the fabric cover located to align on the plurality of rings of the binder assembly upon closure of the fabric cover allowing portions of the rings to pass through the fabric cover to extend from the exterior surface along one side of the writing surface.

2. A portfolio according to claim 1, further comprising:
illumination elements located in the spine and oriented to cover the writing surface.

3. A portfolio according to claim, further comprising:
at least a first flat sheet insert having an edge along which are located a plurality of cuts spaced to correspond the plurality of rings of the binder assembly.

4. A portfolio according to claim 3, further comprising:
the flat sheet insert including magnet elements for holding to the flat sheet insert to magnetically susceptible backings.

5. A portfolio according to claim 4, the flat sheet insert further comprising:
a page retainer located along one major side of the flat sheet insert.

6. A portfolio according to claim 5, the flat sheet insert further providing a sheet protector.

7. A portfolio according to claim 1, further comprising:
an organizer bag including a front accessible pocket for receiving the portfolio.

8. A mobile office organizer comprising:
a portfolio comprising including a fabric cover having interior and exterior major surfaces and a perimeter, a closure disposed along the perimeter for closing the fabric cover along a fold, a spine located on the exterior major surface running transversely across the exterior major surface and roughly dividing the exterior major surface into first and second sections, a writing surface located on a portion of the first section of the exterior major surface adjacent the spine, a binder assembly including a plurality of rings extending from the interior major surface parallel with the spine, the spine and the binder assembly defining a fold in the fabric cover between them, and a plurality of openings through the fabric cover located to align on the plurality of rings of the binder assembly upon closure of the fabric cover allowing portions of the rings to pass through the fabric cover to extend from the exterior surface along one side of the writing surface; and
an organizer bag including a front accessible pocket for receiving the portfolio.

9. A mobile office organizer according to claim 8, further comprising:
illumination elements located in the spine and oriented to cover the writing surface.

10. A mobile office organizer according to claim 8, further comprising:
at least a first flat sheet insert having an edge along which are located a plurality of cuts spaced to correspond the plurality of rings of the binder assembly.

11. A mobile office organizer according to claim 10, further comprising:
the flat sheet insert including magnet elements for holding to the flat sheet insert to magnetically susceptible backings.

12. A mobile office organizer according to claim 11, the flat sheet insert further comprising:
a page retainer located along one major side of the flat sheet insert.

13. A mobile office organizer according to claim 5, the flat sheet insert further providing a sheet protector.
